(19) United States
(12) Patent Application Publication
(10) Pub. No.: US 2020/0068310 A1
(43) Pub. Date: Feb. 27, 2020

(54) BROUGHT-IN DEVICES AD HOC MICROPHONE NETWORK

(71) Applicant: Panasonic Automotive Systems Company of America, Division of Panasonic Corporation of North America, Peachtree City, GA (US)

(72) Inventors: CHRISTOPHER LEE SULLIVAN, JR., FARMINGTON HILLS, MI (US); JONATHAN R. LANE, WHITMORE LAKE, MI (US)

(73) Assignee: Panasonic Automotive Systems Company of America, Division of Panasonic Corporation of North America

(21) Appl. No.: 16/545,117

(22) Filed: Aug. 20, 2019

Related U.S. Application Data
(60) Provisional application No. 62/720,985, filed on Aug. 22, 2018.

(51) Int. Cl. H04R 5/04; H04R 3/00; B60R 11/02

(52) U.S. Cl. CPC H04R 5/04; H04R 2499/13; B60R 11/0247; H04R 3/005

(57) ABSTRACT

A motor vehicle includes at least one first microphone permanently installed in the motor vehicle. An electronic processor is communicatively coupled to the first microphone and receives a first microphone signal from the first microphone. The electronic processor establishes communication with a personal mobile electronic device brought into a passenger compartment of the motor vehicle by a human user. The personal mobile electronic device has a second microphone. The electronic processor receives a second microphone signal from the second microphone, and performs advanced audio processing dependent upon the first microphone signal and the second microphone signal.

### CROSS-REFERENCED TO RELATED APPLICATIONS

This application claims benefit of U.S. Provisional Application No. 62/720,985 filed on Aug. 22, 2018, the disclosure of which is hereby incorporated by reference in its entirety for all purposes.

### FIELD OF THE INVENTION

The disclosure relates to microphones used in a motor vehicle.

### BACKGROUND OF THE INVENTION

Microphones are expensive to integrate into a vehicle, and the need for more microphones in the vehicle cabin is increasing as active noise cancellation, speech recognition, in-car communications systems, etc. are growing more popular. Presently, the only solution is to incorporate more and more microphones, which adds substantial cost. However, portable electronic devices such as smartphones and tablets are brought into vehicles with great regularity, and these devices almost always include at least one built-in microphone.

### SUMMARY

The present invention may include a system wherein the portable electronic devices that have been brought into a vehicle's cabin communicate their microphone signals, via either a wired or wireless connection, to the vehicle's audio processing system. In this way, the microphones of the brought-in devices form a scalable ad hoc microphone network that is made available to the vehicle's audio processing system.

The microphone signals may then be used to perform or improve the quality of any number of multi-microphone audio tasks such as active noise cancellation, noise suppression, automatic speech recognition pre-processing, or in-car communication. These tasks, along with many others, can usually be performed more satisfactorily as more microphone signals are made available.

In one embodiment, the microphone signals can be grouped into one of two categories: noise-capturing or signal-capturing. The selected category of each microphone may be determined adaptively based on properties of the observed signal. If the microphone signal is identified as noise-capturing, it can be used as a reference for noise cancellation or suppression. On the other hand, if the microphone signal is identified as signal-capturing, it can be used for directionality processing, in-car communication, hands-free telephony, speech recognition, etc.

In another embodiment, specifically tailored to in-car communication, all brought-in device microphones are assumed to pick up voice signals from each vehicle occupant. In this way, every occupant with a device can communicate over the in-car communication system, even though the vehicle itself does not contain a large number of built-in microphones.

In yet another embodiment, all brought-in device microphones are assumed to pick up primarily the cabin noise. This is most applicable when the driver is alone in the vehicle, with the device either out in the open or left in his or her pocket, purse, etc. Here, signal-capturing microphones built into the vehicle pick up the driver's speech, while the brought-in device microphones reference the cabin noise, so that noise cancellation and suppression systems provide improved hands-free telephony and automatic speech recognition performance.

In one embodiment, the invention comprises a motor vehicle including at least one first microphone permanently installed in the motor vehicle. An electronic processor is communicatively coupled to the first microphone and receives a first microphone signal from the first microphone. The electronic processor establishes communication with a personal mobile electronic device brought into a passenger compartment of the motor vehicle by a human user. The personal mobile electronic device has a second microphone. The electronic processor receives a second microphone signal from the second microphone, and performs advanced audio processing dependent upon the first microphone signal and the second microphone signal.

In another embodiment, the invention comprises an audio method for a motor vehicle, including permanently installing at least one first microphone in the motor vehicle. A first microphone signal is received from the first microphone. Communication is established with a personal mobile electronic device brought into a passenger compartment of the motor vehicle by a human user. The personal mobile electronic device has a second microphone. A second microphone signal is received from the second microphone. Advanced audio processing is performed dependent upon the first microphone signal and the second microphone signal.

In yet another embodiment, the invention comprises a motor vehicle including a plurality of first microphones permanently installed in the motor vehicle. An electronic processor is communicatively coupled to the first microphones and receives a respective first microphone signal from each of the first microphones. The electronic processor establishes communication with each of a plurality of personal mobile electronic devices brought into a passenger compartment of the motor vehicle by at least one human user. Each of the personal mobile electronic devices has a respective second microphone. The electronic processor receives a respective second microphone signal from each of the second microphones, and performs advanced audio processing dependent upon the first microphone signals and the second microphone signals.

An advantage of the present invention is that using the microphones from brought-in devices reduces the total number of microphones that the vehicle manufacturer must include in the vehicle, and expands audio processing potential. The invention enables a higher level of audio processing without the high cost of permanently installing microphones in the vehicle.

### BRIEF DESCRIPTION OF THE DRAWINGS

A better understanding of the present invention will be had upon reference to the following description in conjunction with the accompanying drawings.

FIG. 1 is a block diagram of one embodiment of an automotive microphone network arrangement of the present invention.

FIG. 2 is a flow chart of one embodiment of an audio method of the present invention for a motor vehicle.

### DETAILED DESCRIPTION OF THE PREFERRED EMBODIMENTS

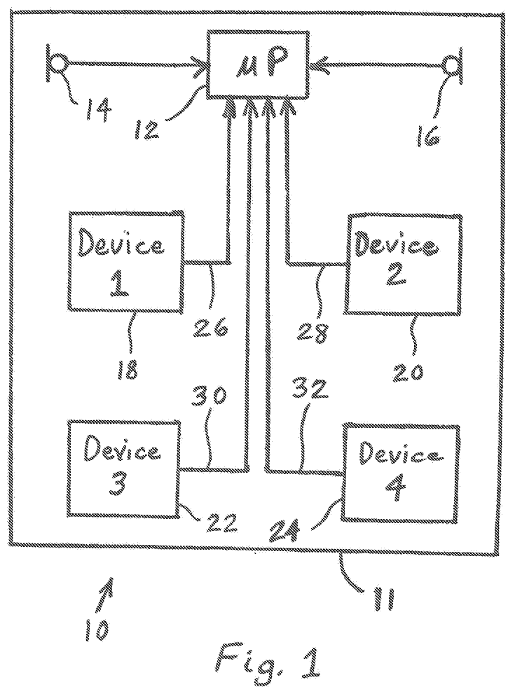

FIG. 1 illustrates one embodiment of an automotive microphone network arrangement 10 of the present invention in a motor vehicle 11. Arrangement 10 includes a central processor 12, a first permanently installed microphone 14, a second permanently installed microphone 16, a first brought-in electronic device 18, a second brought-in electronic device 20, a third brought-in electronic device 22, and a fourth brought-in electronic device 24. Brought-in devices 18, 20, 22 and 24 may be any portable electronic device having a microphone, such as a cell phone, tablet computer, or laptop computer, for example. Brought-in devices 18, 20, 22 and 24 may be carried into and carried out of vehicle 11 by human passengers of vehicle 11, perhaps as frequently as at the start and end of each trip, or at each instance of the engine ignition being turned on or off.

Brought-in devices 18, 20, 22 and 24 may transmit respective audio signals 26, 28, 30 and 32, captured by their respective microphones, to processor 12. Audio signals 26, 28, 30 and 32 may be transmitted to processor 12 via a wireless or wired audio transfer connection.

Processor 12 may request a steady audio stream from each of brought-in devices 18, 20, 22 and 24, just as if these devices were microphones built into vehicle 11. Processor 12 may then use this additional microphone data to perform advanced audio processing such as noise cancellation, in-car communication, etc.

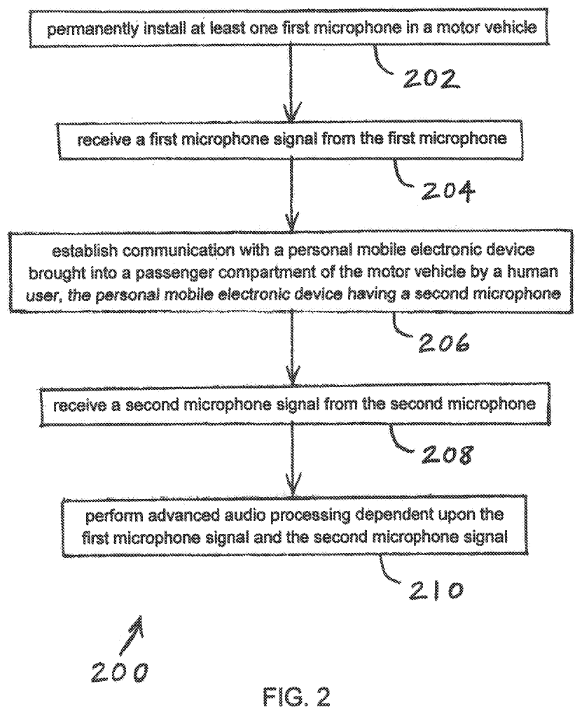

FIG. 2 illustrates one embodiment of an audio method 200 of the present invention for a motor vehicle. In a first step 202, at least one first microphone is permanently installed in the motor vehicle. For example, microphones 14, 16 may be permanently installed in a dashboard, instrument cluster, console, or steering wheel of vehicle 11.

Next, in step 204, a first microphone signal is received from the first microphone. For example, a signal from one of microphones 14, 16 may be received by processor 12.

In a next step 206, communication is established with a personal mobile electronic device brought into a passenger compartment of the motor vehicle by a human user. The personal mobile electronic device has a second microphone. For example, brought-in devices 18, 20, 22 and 24 may be communicatively coupled to processor 12 via a wireless or wired audio transfer connection. Each of brought-in devices 18, 20, 22 and 24 may have its own respective microphone.

In step 208, a second microphone signal is received from the second microphone. For example, processor 12 may receive audio signals 26, 28, 30 and 32 based on the sounds captured by the microphones of respective brought-in devices 18, 20, 22 and 24.

In a final step 210, advanced audio processing is performed dependent upon the first microphone signal and the second microphone signal. For example, processor 12 may use a steady audio stream from the microphones of each of brought-in devices 18, 20, 22 and 24 as well as steady audio streams from permanently-installed microphones 14, 16 to perform advanced audio processing such as noise cancellation, in-car communication, etc.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
at least one first microphone permanently installed in the motor vehicle;
an electronic processor communicatively coupled to the first microphone and configured to:
receive a first microphone signal from the first microphone;
establish communication with a personal mobile electronic device brought into a passenger compartment of the motor vehicle by a human user, the personal mobile electronic device having a second microphone;
receive a second microphone signal from the second microphone; and
perform advanced audio processing dependent upon the first microphone signal and the second microphone signal.

2. The motor vehicle of claim 1 wherein the at least one first microphone comprises a plurality of first microphones permanently installed in the motor vehicle, the electronic processor being communicatively coupled to each of the first microphones and being configured to:
receive a respective first microphone signal from each of the first microphones; and
perform advanced audio processing dependent upon each of the first microphone signals and the second microphone signal.

3. The motor vehicle of claim 1 wherein the electronic processor is configured to:
establish communication with a plurality of personal mobile electronic devices brought into a passenger compartment of the motor vehicle by at least one human user, each of the personal mobile electronic devices having a respective second microphone;
receive a respective second microphone signal from each of the second microphones; and
perform advanced audio processing dependent upon the first microphone signal and each of the second microphone signals.

4. The motor vehicle of claim 1 wherein the advanced audio processing comprises noise cancellation.

5. The motor vehicle of claim 1 wherein the advanced audio processing comprises in-car communication.

6. The motor vehicle of claim 1 wherein the advanced audio processing comprises speech recognition.

7. The motor vehicle of claim 1 wherein the advanced audio processing comprises noise suppression.

8. The motor vehicle of claim 1 wherein the advanced audio processing comprises directionality processing.

9. The motor vehicle of claim 1 wherein the advanced audio processing comprises hands-free telephony.

10. An audio method for a motor vehicle, the method comprising:
permanently installing at least one first microphone in the motor vehicle;
receiving a first microphone signal from the first microphone;
establishing communication with a personal mobile electronic device brought into a passenger compartment of the motor vehicle by a human user, the personal mobile electronic device having a second microphone;
receiving a second microphone signal from the second microphone; and
performing advanced audio processing dependent upon the first microphone signal and the second microphone signal.

11. The method of claim 10 wherein the permanently installing includes permanently installing a plurality of first microphones in the motor vehicle, the receiving of the first microphone signal step includes receiving a respective first microphone signal from each of the first microphones, and the performing step includes performing advanced audio processing dependent upon each of the first microphone signals and the second microphone signal.

12. The method of claim 10 wherein the establishing communication step includes establishing communication with a plurality of personal mobile electronic devices brought into a passenger compartment of the motor vehicle by at least one human user, each of the personal mobile electronic devices having a respective second microphone, the receiving of the second microphone signal step includes receiving a respective second microphone signal from each of the second microphones, and the performing step includes performing advanced audio processing dependent upon the first microphone signal and each of the second microphone signals.

13. The method of claim 10 wherein the advanced audio processing comprises noise cancellation.

14. The method of claim 10 wherein the advanced audio processing comprises in-car communication.

15. The method of claim 10 wherein the advanced audio processing comprises speech recognition.

16. The method of claim 10 wherein the advanced audio processing comprises noise suppression.

17. The method of claim 10 wherein the advanced audio processing comprises directionality processing.

18. The method of claim 10 wherein the advanced audio processing comprises hands-free telephony.

19. A motor vehicle, comprising:
a plurality of first microphones permanently installed in the motor vehicle;
an electronic processor communicatively coupled to the first microphones and configured to:
receive a respective first microphone signal from each of the first microphones;
establish communication with each of a plurality of personal mobile electronic devices brought into a passenger compartment of the motor vehicle by at least one human user, each of the personal mobile electronic devices having a respective second microphone;
receive a respective second microphone signal from each of the second microphones; and
perform advanced audio processing dependent upon the first microphone signals and the second microphone signals.

20. The motor vehicle of claim 19 wherein the advanced audio processing comprises noise cancellation, in-car communication, speech recognition, noise suppression, directionality processing, and/or hands-free telephony.
